(19) United States
(12) Patent Application Publication
(10) Pub. No.: US 2010/0010806 A1
(43) Pub. Date: Jan. 14, 2010

(54) Storage system for symptom information of Traditional Chinese Medicine (TCM) and method for storing TCM symptom information

(76) Inventors: Li Sha Bi, Beijing (CN); Chen Chen, Beijing (CN); Lin Liu, Beijing (CN); Ning Liu, Beijing (CN); Da Min Sun, Beijing (CN)

Correspondence Address: HARNESS, DICKEY & PIERCE, P.L.C., P.O.BOX 8910, RESTON, VA, 20195, US

(21) Appl. No.: 12/457,971

(22) Filed: Jun. 26, 2009

(30) Foreign Application Priority Data
Jun. 27, 2008 (CN) 200810131763.4

(51) Int. Cl. G06F 17/21

(52) U.S. Cl. 704/10

(57) ABSTRACT

A storage system is disclosed for symptom information of Traditional Chinese Medicine (TCM). In at least one embodiment, the system includes a processing module, a TCM standard data module and a storage module, wherein: a TCM specialized glossary and the correlated attributes of the TCM specialized glossary are stored in said TCM standard data module; the processing module is used for dividing the TCM symptom information into at least one phrase, matching the phrase(s) on the basis of the TCM specialized glossary so as to obtain terms belonging to said TCM specialized glossary, for establishing correlated relationships of terms in the phrase(s) according to the correlation attributes in the TCM specialized glossary, and for storing the terms for which a correlated relationship has been established as structured data in said storage module. At least one embodiment of the present invention further discloses a method for storing TCM symptom information. By implementing at least one embodiment of the present invention, symptom information recorded in any language customary to doctors can be accepted, thus reducing the complexity in recording symptom information, thereby facilitating the input thereof by the doctor.

### PRIORITY STATEMENT

The present application hereby claims priority under 35 U.S.C. §119 on Chinese patent application number CN 200810131763.4 filed Jun. 27, 2008, the entire contents of which are hereby incorporated herein by reference.

### FIELD

At least one embodiment of the present invention generally relates to the information processing field, in particular to a storage system for symptom information of Traditional Chinese Medicine (TCM) and a method for storing TCM symptom information.

### BACKGROUND

In the process of TCM diagnosis, doctors normally obtain the symptoms of patients by observing, listening, smelling, asking questions and checking their pulse, etc., and then recording this symptom information in specialist language. With the development of computer technology, computers have gradually been applied to TCM diagnosis. For example, Chinese patent application no. 95111609.6, the entire contents of which are hereby incorporated herein by reference, has disclosed a computer-aided diagnosis system for TCM.

Different from most of the fields in which computers are used, when a TCM doctor records the symptom information of their patients, the way in which the language is organized is usually quite arbitrary. For example, in the case of a patient having the same symptom, a watery runny nose, some TCM doctors may record it as “watery runny nose”, while others may record it as “runny nose watery”. When such symptom information is recorded on a computer, this makes the use of computers for the statistical analysis of such symptoms very difficult due to the specific expressions recorded being different.

In the computer-aided TCM diagnosis system disclosed in the Chinese patent application no. 95111609.6, the initials of the Chinese phonetic alphabet (Pinyin) of the symptom information are used as a code for the symptom information. This requires the doctors to remember this code and to input the corresponding code when recording the symptom information. Such a system receives uniform codes, rather than doctors' personalized expressions, thus facilitating the performance of subsequent statistical analysis using the computer. However, since the codes are not consistent with the language habits of individual doctors they are very inconvenient for the doctors to input, which can lead to reduced efficiency in inputting the symptom information. In addition, since the doctors are required to remember these codes, it increases the degree of complexity in using such a system, thus placing an extra burden on doctors. If the doctor forgets a particular code at a certain time, this will result in it not being possible to input the corresponding symptom, thus delaying the whole diagnosis procedure.

### SUMMARY

Therefore, there is an urgent need for a TCM symptom information storage solution which can solve or even improve upon at least one of the above-mentioned problems.

In view of the situation, at least one embodiment of the present invention proposes a storage system for symptom information of Traditional Chinese Medicine so as to reduce its level of complexity when used and to increase its efficiency. At least one embodiment of the present invention further proposes a method for storing TCM symptom information.

Therefore, at least one embodiment of the present invention provides a storage system for TCM symptom information, comprising a processing module, a TCM standard data module and a storage module, wherein:

a TCM specialized glossary and the correlated attributes of said TCM specialized glossary are stored in said TCM standard data module;

said processing module is used for dividing the TCM symptom information into at least one phrase, for matching said phrase(s) according to said TCM specialized glossary so as to obtain from said phrase(s) terms belonging to said TCM specialized glossary, for establishing correlated relationships between the terms in said phrase(s) according to the correlated attributes of said TCM specialized glossary, and for storing the terms for which the correlated relationships have been established as structured data in said storage module; and

said storage module is used for storing said structured data.

At least one embodiment of the storage system for TCM symptom information further comprises an interface module for receiving said inputted TCM symptom information.

In at least one embodiment, the processing module comprises: a dividing unit for dividing said TCM symptom information into at least one phrase; a matching unit for matching said phrase(s) according to said TCM specialized glossary, so as to obtain from said phrase the terms belonging to said TCM specialized glossary; a first correlating unit for establishing correlated relationships between the terms in said phrase(s) according to the correlated attributes of said TCM specialized glossary in the TCM standard data module; and a storage unit for storing in said storage module the terms for which the correlated relationships have been established as structured data.

In at least one embodiment, the dividing unit comprises: a sentence dividing unit for dividing said TCM symptom information into at least one sentence; and a phrase dividing unit for dividing said sentence(s) into at least one phrase.

In at least one embodiment, the TCM standard data module further stores the classifications of said TCM specialized glossary; and said processing module further comprises a classifying unit for classifying the terms obtained by matching according to the classifications of said TCM specialized glossary.

In at least one embodiment, the processing module further comprises a second correlating unit for establishing a correlated relationship for any terms in a current phrase for which a correlated relationship with other terms in the current phrase could not be established, using the phrase before or after the current phrase according to the correlated attributes of said TCM specialized glossary.

In at least one embodiment, the storage unit is further used for storing in said storage module terms in said phrase(s) for which a correlated relationship could not be established.

In at least one embodiment, the present invention further provides a method for storing of Traditional Chinese Medicine symptom information, which method comprises:

dividing the TCM symptom information into at least one phrase;

matching said phrase(s) according to the pre-stored TCM specialized glossary, so as to obtain from said phrase(s) terms belonging to said TCM specialized glossary;

establishing correlated relationships between the terms in said phrase(s) according to the correlated attributes in the pre-stored TCM specialized glossary; and

storing the terms for which correlated relationships have been established as structured data.

In at least one embodiment, the steps of dividing the TCM symptom information into at least one phrase comprise: dividing said TCM symptom information into at least one sentence; and dividing said sentence into at least one phrase.

In at least one embodiment, the method further comprises: establishing a correlated relationship for any term in the current phase for which a correlated relationship with other terms in the current phase could not be established, using a phrase before or after the current phrase and according to the correlated attributes in said TCM specialized glossary.

In at least one embodiment, the method further comprises: storing any term in said phrase(s) for which a correlated relationship could not be established.

In at least one embodiment, the method further comprises: classifying said terms according to the classifications of said pre-stored TCM specialized glossary.

In at least one embodiment of the method, the TCM specialized glossary is encoded using a digital code in advance; and after said terms have been obtained through the process of matching, the digital codes corresponding to said terms are used for processing.

It can be seen from the above solution that, since at least one embodiment of the present invention divides the TCM symptom information inputted by the doctor into phrases in advance, and then matches the terms in the phrases according to the preset TCM specialized glossary, and establishes correlated relationships between the terms obtained by matching with those belonging to the TCM specialized glossary, structured data are formed, this facilitates the subsequent statistical processing and other processing performed by the computer. According to the technical solution of at least one embodiment of the present invention, symptom information can be received and recorded in any customary language a doctor wishes, thus reducing the level of complexity in recording symptom information and facilitating the inputting of information into the system by a doctor. Since the doctor does not have to change his habits or additionally convert what they have already memorized, the present invention can improve efficiency in inputting symptom information. Furthermore, since doctors do not need to memorize any additional information, the problem of failing to correctly input symptom information due to forgetting the specific codes is no longer an issue.

Furthermore, in at least one embodiment of the present invention, the TCM specialized glossary can also be encoded by using digital codes, and after the terms have been matched and obtained, the computer can use the corresponding digital codes to carry out the processing, rather than processing in the Chinese language, thereby further increasing the processing speed.

### BRIEF DESCRIPTION OF THE DRAWINGS

FIG. 1 is a structural diagram of a TCM symptom information storage system in an embodiment of the present invention;

FIG. 2 is a flowchart of the method for storing TCM symptom information in an embodiment of the present invention; and

FIG. 3 is a structural diagram of a processing module in the system shown in FIG. 1.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In order to make the objects, the technical solution and advantages of the present invention clearer, the present invention is explained in further detail hereinbelow by way of the embodiments.

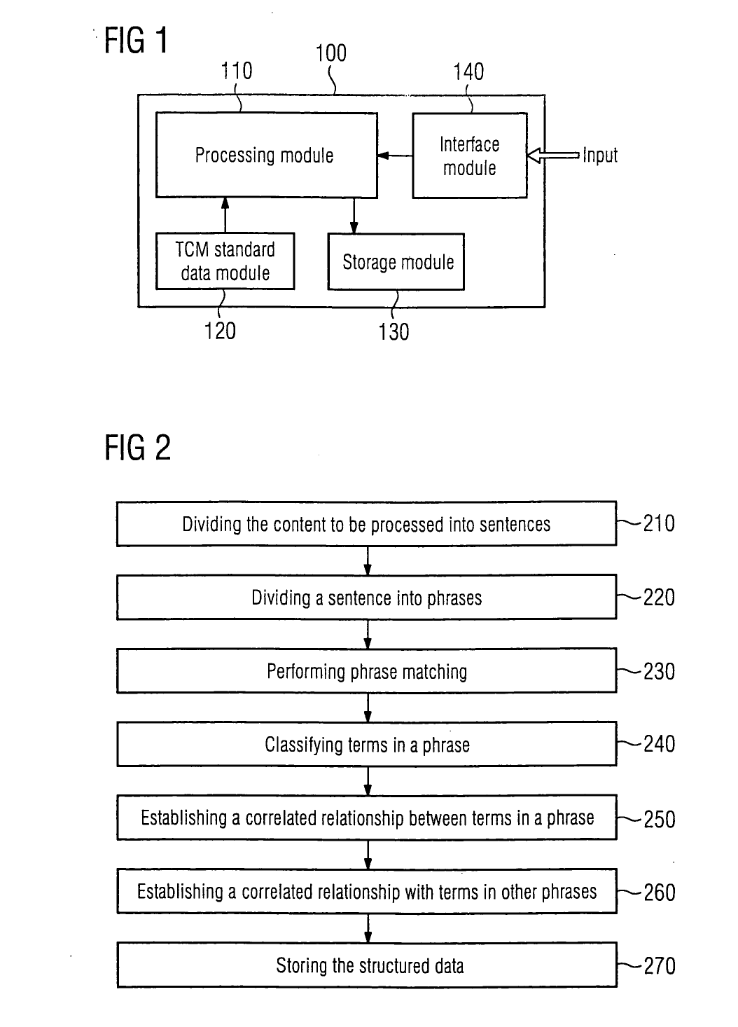

FIG. 1 is a structural diagram of a TCM symptom information storage system 100 in an embodiment of the present invention. As shown in FIG. 1, the system 100 comprises a processing module 110, a TCM standard data module 120 and a storage module 130. The system 100 can further comprise an interface module 140.

In the system 100 shown in FIG. 1, a TCM specialized glossary is stored in the TCM standard data module 120. This TCM specialized glossary can be obtained from the relevant official standards (such as “Terminology of clinical diagnostics and TCM therapy/symptoms part” of the Chinese national standard no. GB/T 16751.2-1997), and from original works in the field of TCM (such as, “Diagnostics of Traditional Chinese Medicine”, “Traditional Chinese Internal Medicine”, etc.), the entire contents of each of which are hereby incorporated herein by reference. Furthermore, according to the symptoms obtained from corresponding TCM standards, works or clinical practice, the correlated attributes of the TCM specialized glossary are stored in the TCM standard data module 120, and the correlated attributes of a term indicate with which other terms a correlated relationship can be established for the term, thus indicating the TCM symptoms. For example, the correlated attribute “head” indicates that “head” can establish a correlated relationship with terms such as “ache”, “dizzy”, etc, and the correlated attributes of “ache” indicate that “ache” can establish a correlated relationship with terms such as “head”, “limb”, “pain”, etc.

Furthermore, in the TCM standard data module 120, this TCM specialized glossary can be classified as required and the classification information of the TCM specialized glossary can be stored. For example, the TCM specialized glossary can be classified by location, nature, description, degree, time, cause and degree of increase or decrease, etc. In the piece of TCM symptom information of “splitting headache in the afternoon, degree of severity changing with time, and increasing or decreasing with change in mood”, “head” indicates the location, “ache” indicates the nature, “splitting” indicates the description, “degree of severity changing with time” indicates the degree, “in the afternoon” indicates the time, “change in mood” indicates the cause, and “increasing or decreasing” indicates the degree of increase or decrease.

The storage module 130 is used for storing the structured data obtained by processing in the processing module 110.

The interface module 140 can receive the TCM symptom information inputted by the doctor, and provide the received TCM symptom information to the processing module 110 for processing. When the processing module 110 processes the TCM symptom information files already recorded in the computer, this interface module 140 may not be needed, and the TCM symptom information is read directly from the files.

The processing module 110 divides the TCM symptom information to be processed into at least one phrase, and makes a match of the phrase(s) according to the TCM specialized glossary stored in the TCM standard data module 120, so as to obtain the terms belonging to the TCM specialized glossary, and then establishes the correlated relationships between the terms obtained by matching from the phrase(s) according to the correlated attributes of the TCM specialized glossary stored in the TCM standard data module 120, and stores in the storage module 130, as structured data, the terms for which correlated relationships have been established.

When dividing the TCM symptom information into phrases, the processing module 110 can directly divide the TCM symptom information into phrases, and it can also divide the TCM symptom information first into at least one sentence, and then further divide the sentence into phrases.

When the classifications of the TCM specialized glossary are stored in the TCM standard data module 120, the processing module 110 can also classify accordingly the terms obtained by matching, thus simplifying future storage, analysis and statistical evaluation.

Due to a doctor's individual language habits, it is possible for terms in certain phrases not to be able to form a correlated relationship with other terms in said phrase. In such a case, the processing module 110 can further use terms in a phrase before or after the current phrase for establishing a correlated relationship for such terms according to the correlated attributes of the TCM specialized glossary in the TCM standard data module 120. The processing module 110 also stores the terms for which a correlated relationship has been established in this way as structured data in the storage module 130.

Since some terms can independently express a symptom it is not necessary to establish a correlated relationship with other terms. As a result it is possible for terms to occur in some phrases for which it is not possible to establish a correlated relationship with other terms in the phrase or with the terms in a phrase before or after it. In such a case, the processing module 110 can also store the terms, for which a correlated relationship could not be established in the phrases, in said storage module 130.

Furthermore, in an embodiment of the present invention, digital codes can be used, in advance, to encode the TCM specialized glossary in the TCM standard data module 120, the digital codes corresponding to the TCM specialized glossary being stored in the TCM standard data module 120. After the processing module 110 has matched and obtained the terms in the phrases further processing is carried out using the digital codes corresponding to them, for example for establishing correlated relationships, classification, storage, etc. Due to the fact that a computer processes digital codes at a much higher speed than Chinese characters, an embodiment of the present invention can therefore also increase the speed of the whole storage process.

A particular processing method of the processing module 110 is described below. FIG. 2 is a flowchart of an embodiment of this method. As shown in FIG. 2, this method comprises the following steps:

In step 210, TCM symptom information to be processed is divided into at least one sentence.

In a Chinese expression, the end of a sentence is normally indicated by punctuation marks such as a full stop “∘” or “.” or an exclamation mark “! ” etc. In the field of TCM the end of a sentence can also be indicated by starting a new paragraph. Therefore, in this step, sentences can be divided by punctuation marks or paragraph marks, in order to represent the end of the sentence.

In step 220, the sentences are divided into at least one phrase.

In a sentence, the phrases are normally separated by punctuation marks such as a comma “,” a pause sign “ [symbol] ”, or a semicolon “;”, etc., or by conjunctions such as “and”, “or”, etc. Therefore, in this step, the phrases can be divided by these punctuation marks or conjunctions. For example, for the sentence “pain in a limb or discomfort”, the conjunction “or” can be used to divide the sentence into two phrases “pain in a limb” and “discomfort”.

In addition, step 210 and step 220 can be combined into a single step, namely directly dividing the TCM symptom information to be processed into at least one phrase according to punctuation marks, paragraph marks, conjunctions, etc.

In step 230, the phrases are matched according to the TCM specialized glossary stored in the TCM standard data module 120, to obtain the terms belonging to the TCM specialized glossary in the phrase.

For example, for the phrase “a watery runny nose”, since the terms “watery” and “runny nose” are present in the TCM standard data module 120, the two terms “watery” and “runny nose” can be obtained by matching. While for the phrases “pain in a limb” and “discomfort”, the terms “limb”, “pain” and “discomfort” can be obtained by matching them respectively.

In step 240, the terms obtained by matching can be further classified according to the classifications of the TCM specialized glossary in the TCM standard data module 120. For example, “runny nose” and “limb” are classified as locations, and “pain”, “discomfort” and “watery” are classified as nature. This can facilitate subsequent statistical processing and displaying of them for others to read.

In step 250, according to the correlated attributes of the TCM specialized glossary stored in the TCM standard data module 120, correlated relationships are established for the terms in the phrases, so as to indicate the corresponding symptoms.

For the terms “watery” and “runny nose” in the phrase “a watery runny nose”, a correlated relationship can be established between the two terms according to the correlated attributes of “watery” and “runny nose” in the TCM standard data module 120, so as to indicate a symptom. For the terms “limb” and “pain” in the phrase “pain in a limb”, a correlated relationship can also be established between them, so as to indicate a symptom. However, for the term “discomfort” in the phrase “discomfort”, it has not been possible as yet to establish a correlated relationship with other terms.

As mentioned above, it is possible that, in certain phrases, there are terms for which a correlated relationship with other terms in this phrase cannot be established, and therefore the method can further comprise step 260. In step 260, correlated relationships are established for these terms in combination with the phrase before or after the phrase currently being processed, so as to indicate a symptom.

For example, as regards the term “discomfort”, it is shown how a correlated relationship is established for “discomfort” by combining it with the preceeding phrase “pain in a limb” which includes the two terms “limb” and “pain”. According to the correlated attributes “discomfort”, “limb” and “pain” stored in the TCM standard data module 120, a correlated relationship between “discomfort” and “pain” cannot be established to indicate a symptom. It is however possible to establish a correlated relationship between “discomfort” and “limb” to indicate a symptom, thus establishing a correlated relationship between “discomfort” and “limb”.

In step 270, the terms for which correlated relationships have already been established are stored as structured data in the storage module 130. For example, “limb” and “pain” are stored as one set of structured data, and “discomfort” and “limb” are stored as another piece of structured data in the storage module 130.

It is further possible that terms occurring in certain phrases, (for example “cough”) for which a correlated relationship cannot be established with other terms in this phrase, or with terms in the phrase before or after the current phrase, are also stored in the storage module 130 in this step.

Furthermore, in an embodiment of the method of the present invention, the TCM specialized glossary in the TCM standard data module 120 can be encoded by digital codes in advance and represented by these digital codes. After the processing module 110 has matched and obtained the terms in step 230, these matched and obtained terms are then represented by the digital code corresponding to them, and in the subsequent step, the digital code is used to perform the processing. Due to the use of digital codes, Chinese characters will no longer be processed directly, and these digital codes are much simpler than Chinese characters, thus it is possible to greatly reduce the level of processing complexity and to increase the processing speed.

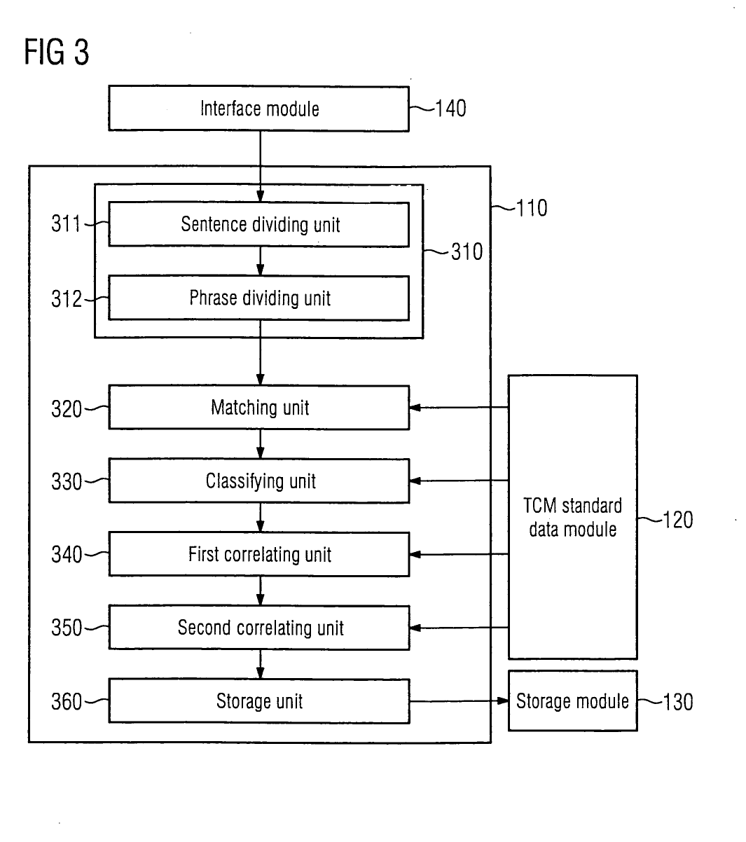

FIG. 3 shows a schematic structural diagram of the processing module 110 in an embodiment of the present invention. As shown in FIG. 3, said processing module 110 comprises: a dividing unit 310, a matching unit 320, a first correlating unit 340 and a storage unit 360. It can further comprise a classifying unit 330 and/or a second correlating unit 350.

In this case, the dividing unit 310 divides the TCM symptom information to be processed into at least one phrase. The matching unit 320 matches the phrases obtained by the dividing unit 310 according to the TCM specialized glossary stored in the TCM standard data module 120, thereby obtaining from the phrases the terms belonging to the TCM specialized glossary. The first correlating unit 340 establishes correlated relationships between the terms in the phrases according to the correlated attributes of the TCM specialized glossary stored in the TCM standard data module 120. The storage unit 360 stores the terms for which correlated relationships have been established as structured data in the storage module 130.

As shown in FIG. 3, the dividing unit 310 can comprise a sentence dividing unit 311 and a phrase dividing unit 312. In this case, the sentence dividing unit 311 first divides the TCM symptom information into at least one sentence, and then the phrase dividing unit 312 divides the sentence obtained from the sentence dividing unit 311 into at least one phrase.

The processing module 110 can further comprise a classifying unit 330, and the TCM standard data module 120 also stores the classifications of the TCM specialized glossary. The classifying unit 330 classifies the terms matched and obtained by the matching unit 320 according to the classifications of the TCM specialized glossary.

In addition, the processing module 110 can further comprise a second correlating unit 350, and the second correlating unit 350 establishes a correlated relationship for any term in the current phrase for which a correlated relationship with other terms in the current phrase cannot yet be established, using a phrase before or after the current phrase, according to the correlated attributes of TCM specialized glossary stored in the TCM standard data module 120.

Furthermore, the storage unit 360 can also store a term (in the case of having only the first correlating unit 340, it means a term for which a correlated relationship with other terms in the phrase cannot be established; and in the case of having both the first correlating unit 340 and the second correlating unit 350, it means a term for which the correlated relationship cannot be established with other terms in the phrase or with terms in a phrase before or after the current phrase) in the phrase, for which a correlated relationship cannot be established, in the storage module 130.

What are described above are merely example embodiments of the present invention, and are not to limit the present invention, and any modification, equivalent substitution and improvement within the spirit and principle of the present invention should be included in the protective scope of the present invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A storage system for symptom information of Traditional Chinese Medicine (TCM), comprising:
a TCM standard data module to store a TCM specialized glossary and correlated attributes of said TCM specialized glossary;
a processing module to divide the TCM symptom information into at least one phrase, to match the at least one phrase according to the TCM specialized glossary so as to obtain, from the at least one phrase, terms belonging to the TCM specialized glossary, and to establish correlated relationships between the terms in the at least one phrase according to the correlated attributes of the TCM specialized glossary; and
a storage module to store the terms, for which the correlated relationships are established, as structured data.

2. The system as claimed in claim 1, further comprising an interface module to receive the TCM symptom information.

3. The system as claimed in claim 1, wherein said processing module comprises:
a dividing unit to divide the TCM symptom information into the at least one phrase;
a matching unit to match the at least one phrase according to said TCM specialized glossary, so as to obtain from the at least one phrase the terms belonging to said TCM specialized glossary;
a first correlating unit to establish correlated relationships between the terms in the at least one phrase according to the correlated attributes of said TCM specialized glossary; and
a storage unit to store in said storage module the terms for which the correlated relationships have been established as structured data.

4. The system as claimed in claim 3, wherein said dividing unit comprises:
a sentence dividing unit to divide said TCM symptom information into at least one sentence; and
a phrase dividing unit to divide said at least one sentence into at least one phrase.

5. The system as claimed in claim 3, wherein said TCM standard data module further stores the classifications of said TCM specialized glossary; and
said processing module further comprises a classifying unit to classify the terms obtained by matching according to the classifications of said TCM specialized glossary.

6. The system as claimed in claim 3, wherein said processing module further comprises a second correlating unit to establish a correlated relationship for any terms in the current phrase for which a correlated relationship with other terms in the current phrase could not be established, using the phrase before or after the current phrase according to the correlated attributes of said TCM specialized glossary.

7. The system as claimed in claim 3, wherein said storage unit is further used to store, in said storage module, terms in said at least one phrase for which a correlated relationship could not be established.

8. A method for storing symptom information of Traditional Chinese Medicine, the method comprising:
dividing the TCM symptom information into at least one phrase;
matching the at least one phrase according to the pre-stored TCM specialized glossary, so as to obtain, from the at least one phrase, terms belonging to said TCM specialized glossary;
establishing correlated relationships between the terms in the at least one phrase according to the correlated attributes in the pre-stored TCM specialized glossary; and
storing the terms, for which correlated relationships are established, as structured data.

9. The method as claimed in claim 8, wherein the dividing the TCM symptom information into at least one phrase comprise:
dividing said TCM symptom information into at least one sentence; and
dividing said at least one sentence into the at least one phrase.

10. The method as claimed in claim 8, further comprising:
establishing a correlated relationship for any term in the current phase for which a correlated relationship with other terms in the current phase could not be established, using a phrase before or after the current phrase, according to the correlated attributes in said TCM specialized glossary.

11. The method as claimed in claim 8, further comprising:
storing any term in the at least one phrase for which a correlated relationship could not be established.

12. The method as claimed in claim 8, further comprising:
classifying said terms according to the classifications of said pre-stored TCM specialized glossary.

13. The method as claimed in claim 8, wherein in the method said TCM specialized glossary is encoded using a digital code in advance; and
after said terms have been obtained through the process of matching, the digital code corresponding to said terms are used for processing.

14. The system as claimed in claim 6, wherein said storage unit is further used to store, in said storage module, terms in said at least one phrase for which a correlated relationship could not be established.

15. The method as claimed in claim 10, further comprising:
storing any term in the at least one phrase for which a correlated relationship could not be established.

16. A computer readable medium including program segments for, when executed on a computer device, causing the computer device to implement the method of claim 1.
